(19) United States
(12) Patent Application Publication
(10) Pub. No.: US 2015/0189358 A1
(43) Pub. Date: Jul. 2, 2015

(54) Electronic Device, Control Method and Computer Program Product

(71) Applicant: Kabushiki Kaisha Toshiba, Tokyo (JP)

(72) Inventor: Takayasu Tsuchiuchi, Sagamihara Kanagawa (JP)

(21) Appl. No.: 14/465,561

(22) Filed: Aug. 21, 2014

(30) Foreign Application Priority Data
Dec. 27, 2013 (JP) 2013-273250

(51) Int. Cl. H04N 21/41; H04N 21/485

(52) U.S. Cl. CPC H04N 21/4126; H04N 21/485

(57) ABSTRACT

According to one embodiment, an electronic device includes a reception controller and a notification module. The reception controller is configured to receive a browser mode from a reception device. The browser mode is configured to indicate whether a browser of the reception device is executed in a state that a certain kind of data is capable of being read. The notification module is configured to perform notification when it is determined that the browser is capable of reading the certain kind of data based on the browser mode.

### CROSS-REFERENCE TO RELATED APPLICATIONS

This application is based upon and claims the benefit of priority from Japanese Patent Application No. 2013-273250, filed Dec. 27, 2013, the entire contents of which are incorporated herein by reference.

### FIELD

Embodiments described herein relate generally to an electronic device, a control method and a computer program product.

### BACKGROUND

In recent years, the screens of television devices have grown in size, and portable terminals provided with touch panels have become widely used. In response to the changing environment, television viewing styles have been also changed. For example, there is a style in which the portable terminal is operated while viewing a television program.

In addition, there has been proposed a technique that combines broadcasting and communication to provide various services to users. For example, there has been proposed a service that provides, in addition to television programs provided in the broadcasting, contents collaborating with the television programs via a network such as the Internet.

For this purpose, there has been proposed a technique that makes it possible to collaboratively operate a portable terminal and the television device with each other by providing contents associated with the television programs via a network in order to browse the contents with the use of the portable terminal such as a tablet terminal or a smart phone via a network, while a broadcasting station provides the television programs to the television device through broadcasting.

In a conventional technique, however, to operate the portable terminal and the television device in collaboration with each other, it is necessary for the television device to be operated in a mode in which the television device can be operated in collaboration with other device. It is difficult for the portable terminal to recognize the state of the television device while operating on the side of the portable terminal.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a configuration of a broadcasting and communication collaboration system according to a first embodiment;

FIG. 2 is an exemplary block diagram illustrating a hardware configuration of a television device in the first embodiment;

FIG. 3 is an exemplary block diagram illustrating a hardware configuration of a portable terminal in the first embodiment;

FIG. 4 is an exemplary diagram illustrating an example of a software configuration of a companion application to be executed in the portable terminal in the first embodiment;

FIGS. 5A and 5B are exemplary diagrams each illustrating a first transition example of a screen displayed on the portable terminal in the first embodiment;

FIGS. 6A and 6B are exemplary diagrams each illustrating a second transition example of a screen displayed on the portable terminal in the first embodiment;

FIG. 7 is an exemplary flowchart illustrating processing with respect to the display control of a terminal collaboration button in the television device and the portable terminal in the first embodiment;

FIG. 8 is an exemplary flowchart illustrating processing performed until a URL is transmitted for collaborating with a portable terminal in a television device according to a second embodiment; and

FIG. 9 is an exemplary flowchart illustrating the procedure of processing performed for collaborating with the television device in the portable terminal in the second embodiment.

### DETAILED DESCRIPTION

In general, according to one embodiment, an electronic device comprises a reception controller and a notification module. The reception controller is configured to receive a browser mode from a reception device. The browser mode is configured to indicate whether a browser of the reception device is executed in a state that a certain kind of data is capable of being read. The notification module is configured to perform notification when it is determined that the browser is capable of reading the certain kind of data based on the browser mode.

### First Embodiment

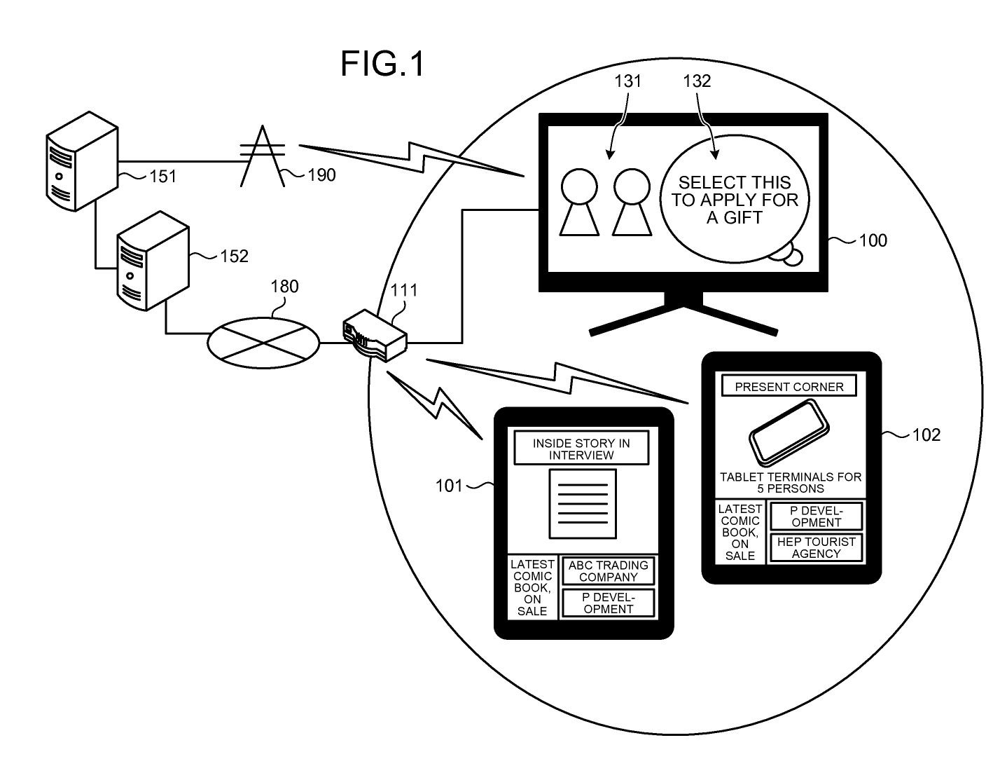

FIG. 1 is a block diagram illustrating the configuration of a broadcasting and communication collaboration system according to a first embodiment. The broadcasting and communication collaboration system illustrated in FIG. 1 comprises a radio wave tower 190, a broadcast transmission server 151, and a data distribution server 152. Furthermore, in the broadcasting and communication collaboration system, there exists a home network beyond a public network 180 to which a data distribution server 152 is connected.

The home network is constructed as a local area network based on a router 111 or the like. The local area network comprises the router 111, a television device 100, a first portable terminal 101, and a second portable terminal 102 that are connected to the public network 180 via the router 111. Here, in the first embodiment, two portable terminals are exemplified. However, this example merely shows that the present embodiment is also applicable with the use of a plurality of portable terminals. Generally, the first embodiment is applicable with the use of one or more portable terminals.

The television device 100 has a function of receiving broadcasting signals transmitted from the radio wave tower 190 to display videos contained in the broadcasting signals. Furthermore, the television device 100 comprises a browser for displaying information received via the public network 180. The first embodiment is explained by exemplifying a portable terminal used as an electronic device. However, the other device may be used as the electronic device.

The portable terminal 101 or 102 is an terminal that can be operated on the touch panel screen provided thereto or the like and has a communication function with the television device 100 or the public network 180 via the router 111.

The broadcast transmission server 151 controls the transmission of broadcasting signals using the radio wave tower 190. There may be a case that the broadcasting signals contain additional information in addition to a usual television program. The additional information corresponds to a television program. The additional information is information for executing an application for collaborating with data communication. The application is distributed from the data distribution server 152.

In the first embodiment, the application to be executed based on the additional information is provided via the public network 180 or the broadcasting signals. For example, it is conceivable that the application contains a script (program) such as JavaScript (registered trademark). The portable terminal 101 or 102, or the television device 100 reads the application thus displaying various contents. Examples of the contents may include any one or more of a text, a still image, and a video.

Here, the television device 100 and the portable terminals 101 and 102 are provided at home and hence, a television viewing style tends to change from a conventional style. For example, it is supposed that a user views a television program displayed on the television device 100 simultaneously with operating the portable terminal 101 or 102.

Accordingly, a broadcasting station that provides television programs has also paid attention to a portable terminal as a second screen. For example, the broadcasting station has considered a method for using the portable terminal as a device for complementing television programs or increasing the value of the television programs.

As such a method for using the portable terminal, a service using “Hybridcast (registered trademark)” is proposed. In the Hybridcast, the television device 100 accesses the data distribution server 152 provided by a service provider (broadcasting station, for example) in accordance with additional information contained in broadcasting signals, receives an application from the data distribution server 152, and executes the application, thereby the television device 100 can achieve a collaboration by a television program provided through the broadcasting signals and contents produced.

For this purpose, it is necessary for the television device 100 to comprise a platform corresponding to the collaboration. The television device 100 in the first embodiment comprises a browser corresponding to the collaboration.

Due to such a configuration, the television device 100 can, for example, overlappingly display contents 132 produced by the application on an image 131 of a television program.

When the browser of the television device 100 comprises an API for collaborating with the portable terminal 101 or 102, the collaboration by the portable terminal 101 or 102 and the television device 100 can be achieved.

For example, the collaborate API of the browser in the television device 100 allows the portable terminal 101 or 102 to recognize a providing source of an application for a portable terminal. Consequently, the portable terminal 101 or 102 accesses a providing source (data distribution server 152, for example) of an application for a portable terminal, and receives and executes the application, thereby the portable terminal 101 or 102 can display contents collaborating with a television program or the like displayed on the television device 100.

However, not all the television programs transmitted through broadcasting signals correspond to the Hybridcast or the like capable of collaborating a broadcasting and a communication. Accordingly, the television device 100 starts the browser incorporated therein in a broadcasting and communication collaboration mode when receiving broadcasting signals of a television program in which the broadcasting and the communication can be collaborated. The broadcasting and communication collaboration mode is a browser mode corresponding to the service in which the broadcasting and the communication are integrated with each other by the Hybridcast.

That is, when the portable terminal 101 or 102 collaborates with the television device 100, it is necessary to confirm whether the browser of the television device 100 is operated in the broadcasting and communication collaboration mode. Therefore, in the first embodiment, the portable terminal 101 or 102 recognizes the current browser mode in the browser of the television device 100, and determines whether the portable terminal 101 or 102 can collaborate with the television device 100.

Next, the configuration in the home network is explained. In the first embodiment, the home network comprises the television device 100 and the portable terminals 101 and 102. Here, in the first embodiment, the connection between the television device 100 and the portable terminal 101 or 102 that is required for transmitting and receiving data has been already established in a local area network.

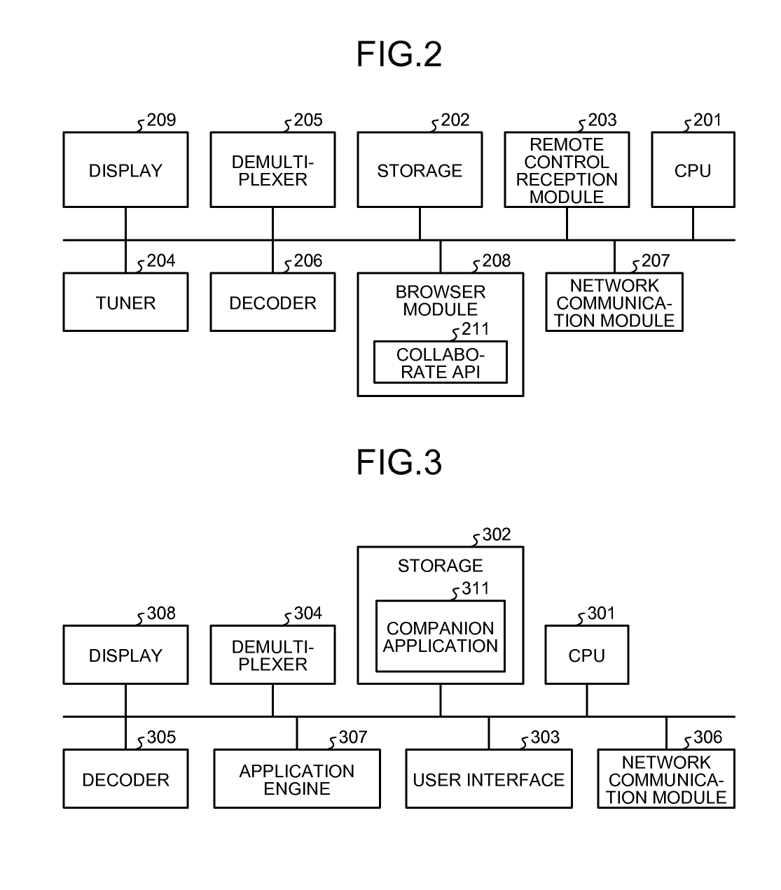

FIG. 2 is a diagram illustrating a hardware configuration of the television device 100 according to the first embodiment. As illustrated in FIG. 2, the television device 100 comprises a central processing unit (CPU) 201, a storage 202, a remote control reception module 203, a tuner 204, a demultiplexer 205, a decoder 206, a network communication module 207, a browser module 208, and a display 209.

The storage 202 stores therein various data including computer programs. The CPU 201 performs various kinds of calculations and processing and also executes computer programs stored in the storage 202.

The remote control reception module 203 receives infrared operation information from a remote controller (not illustrated in the drawings) via an infrared reception module (not illustrated in the drawings). Furthermore, the CPU 201 controls each module in the television device 100 based on the operation information received.

The tuner 204 accepts the selection of a desired channel based on the operation information received by the remote control reception module 203, and receives broadcasting signals selected via an antenna (not illustrated in the drawings). Furthermore, the tuner 204 outputs the received broadcasting signals to the demultiplexer 205.

The demultiplexer 205 separates the broadcasting signals received by the tuner 204 into content information with respect to the broadcasting signals and encoded video data. Here, when the broadcasting signals correspond to the service that integrates the broadcast and the communication, the content information contains additional information (URL for receiving the application, for example) for executing an application that is collaborates with television programs.

The decoder 206 decodes the encoded video data. The content information and the decoded video data are output to the display 209.

The network communication module 207 transmits/receives data to/from the data distribution server 152 via the router 111. In addition, the network communication module 207 uses a wireless communication line and/or a wired communication line to transmit/receive data to/from the first portable terminal 101 or the second portable terminal 102 via the router 111.

For example, when the content information separated in the demultiplexer 205 contains the additional information for executing the application collaborating with the television programs, the network communication module 207 receives an application corresponding to a currently broadcasted television program using a URL (URL of the data distribution server 152, for example) specified based on the additional information.

The browser module 208 comprises a collaborate API 211 thus displaying various contents such as the application or the television programs. The browser module 208 is started in a broadcasting and communication collaboration mode when the broadcasting signals contain the additional information for collaborating with data through communication. The browser module 208 is started in the broadcasting and communication collaboration mode thus reading and executing data (application) provided as the Hybridcast. The browser module 208 also has a browser mode other than the broadcasting and communication collaboration mode according to the types of contents executable. For example, the browser module 208 has, for example, a browser mode corresponding to contents distributed by a service provider via the public network 180.

The browser module 208 executes, when being started in the broadcasting and communication collaboration mode, the application received from the data distribution server 152 thus collaborating with the television programs.

The collaborate API 211 is an API for collaborating a portable terminal (the first portable terminal 101 or the second portable terminal 102, for example) connected via a home network with an application. The collaborate API 211 in the first embodiment is used, by the application read by the browser module 208, for transmitting a URL in which an application to be executed by a portable terminal (the first portable terminal 101 or the second portable terminal 102, for example) is stored, or for exchanging data between an application operated in the browser module 208 and a portable terminal (the first portable terminal 101 or the second portable terminal 102, for example). Due to such a configuration, the collaboration between the television device 100 and a portable terminal (the first portable terminal 101 or the second portable terminal 102, for example) can be achieved based on a television program or the like. Here, the API may transfer an application acquired from a URL directly to a portable terminal (the first portable terminal 101 or the second portable terminal 102, for example), rather than transferring the URL.

The display 209 comprises a display panel or the like, and displays video data decoded by the decoder 206 or an application operated in the browser module 208.

FIG. 3 is a diagram illustrating a hardware configuration of the portable terminal 101 or 102 in the first embodiment. As illustrated in FIG. 3, the portable terminal 101 or 102 comprises a CPU 301, a storage 302, a user interface 303, a demultiplexer 304, a decoder 305, a network communication module 306, an application engine 07, and a display 308. The portable terminal 101 or 102 used is, for example, a tablet terminal or a smartphone; however, any of portable electronic devices provided with a display may be used.

The storage 302 stores therein various kinds of data including a computer program such as a companion application 311. The CPU 301 performs various kinds of calculations or processing and also executes computer programs stored in the storage 302.

The demultiplexer 304 separates information received via the public network 180 into content information and video data. The decoder 305 decodes the video data. When the video data is enciphered, the decoder 305 deciphers the video data and thereafter, decodes the video data. The content information and the decoded video data are output to the display 308.

The network communication module 306 transmits/receives data to/from the other device (the data distribution server 152, for example) connected to the public network 180 through the router 111. Furthermore, the network communication module 306 transmits/receives data to/from the television device 100 via the router 111.

The application engine 307 reads an application, and performs control and display based on the application read thereby. The application engine 307 according to the first embodiment collaborates with the collaborate API 211 of the television device 100 via the network communication module 306, receives an application based on a URL transferred from the collaborate API 211, and performs control and display based on the application received thereby. As the application engine 307 in the first embodiment, a browser or the like capable of processing an HTML file or an XML file may be used.

The display 308 comprises a liquid crystal display panel or the like, and displays an application processed by the application engine 307.

The user interface 303 comprises a touch-sensitive film attached to the surface of the display 308, and acquires position coordinates of a finger or the like with which a user touches on the display 308 as operating information of the user. To be more specific, the touch-sensitive film comprises therein sensors in the X-axis direction and the Y-axis direction. When a user touches on the screen of a portable terminal with a finger or a hand or the like, the touch-sensitive film detects the touch of the finger or the hand or the like and outputs a detection signal containing the coordinates of the touched position to the CPU 301 as the operating information. Here, a state of the touch is not limited to a state of an actual touch, and a state that an object is nearly brought into contact with the display 308 may be considered as a state of the touch.

The CPU 301 in the first embodiment executes the companion application 311 stored in the storage 302 in accordance with the operation of a user. The companion application 311 in the first application is an application having a function for operating the television device 100 and also having a Hybridcast-related function. Furthermore, the companion application 311 is operated in an integrated manner with the application engine 307.

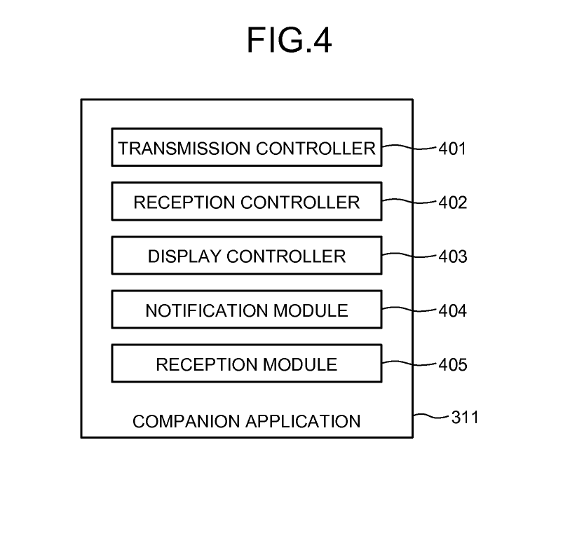

Furthermore, the CPU 301 executes the companion application 311 thus loading various components. FIG. 4 is a diagram illustrating an example of a software configuration of the companion application 311 executed in the portable terminal 101 or 102 according to the first embodiment. As illustrated in FIG. 4, the companion application 311 is executed thus achieving a transmission controller 401, a reception controller 402, a display controller 403, a notification module 404, and a reception module 405.

The display controller 403 displays an operation screen for operating the television device 100 on the display 308.

The reception module 405 receives operations performed by a user with respect to the companion application 311 via the user interface 303.

The transmission controller 401 transmits a confirmation request for a current browser mode of the browser module 208 in the television device 100 to the television device 100 via the network communication module 306. Here, the confirmation request may be periodically transmitted, or may also be transmitted each time when a channel changing operation or the like is performed by the companion application 311.

The reception controller 402 receives a response to the transmitted confirmation request from the television device 100 via the network communication module 306.

The notification module 404 notifies the user of the fact that the portable terminal 101 or 102 is capable of collaborating with the television device 100 if it is confirmed that the browser module 208 in the television device 100 is executed in a broadcasting and communication collaboration mode (that is, a browser mode corresponding to a service that integrates the broadcast and the communication by the Hybridcast) based on the response corresponding to the confirmation request.

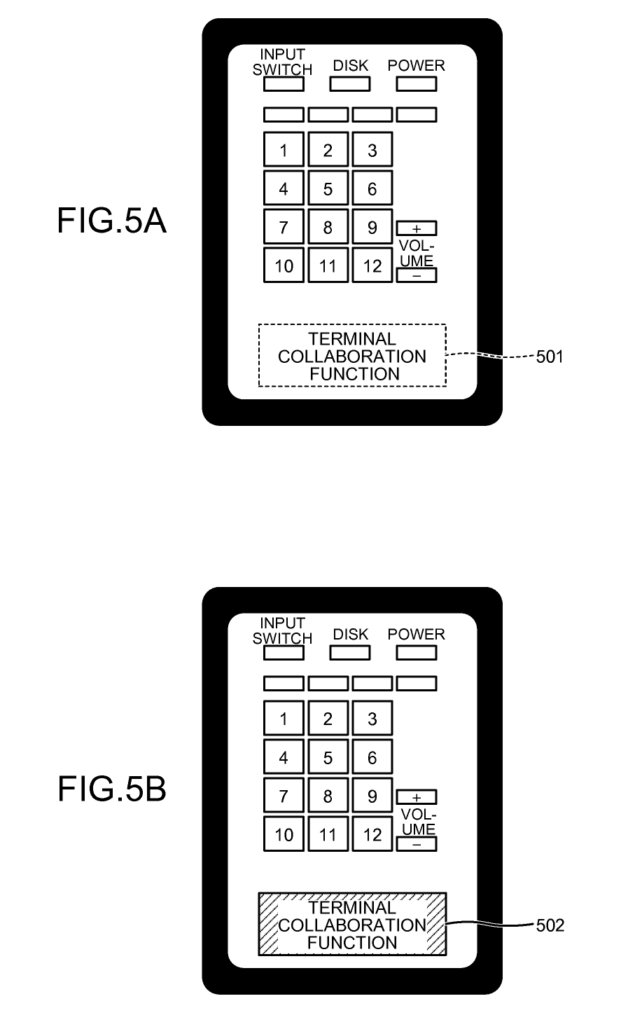

FIGS. 5A and 5B are diagrams each illustrating a first transition example of a screen displayed on the portable terminal 101 or 102. As illustrated in FIG. 5A, when the companion application 311 is executed, the display controller 403 displays an operation screen for operating mainly the television device 100 on the display 308. The operation screen comprises, in addition to buttons for operating the television device 100, a terminal collaboration function button 501 for collaborating the portable terminal 101 or 102 with the television device 100. However, the terminal collaboration function button 501 is, as illustrated in FIG. 5A, displayed in a grayout manner or hidden when the television device 100 does not receive broadcasting signals corresponding to the service that integrates a broadcast and a communication.

Furthermore, when a browser mode received by the reception controller 402 from the television device 100 is the broadcasting and communication collaboration mode, the notification module 404 notifies the user of the fact that the television device 100 may correspond to the collaboration. In the first embodiment, as illustrated in FIG. 5B, the notification module 404 notifies the user of the fact that the portable terminal 101 or 102 is capable of collaborating with the television device 100 by controlling the display controller 403 to display a terminal collaboration function button 502 in a selectable manner, to change in color of the terminal collaboration function button 502, or to flicker the color of the terminal collaboration function button 502.

Here, the first embodiment is not limited to the above-mentioned notification technique. For example, the notification module 404 may make a notification by vibrating the portable terminal 101 or 102, by outputting a sound, or by displaying an image. Furthermore, in addition to these techniques, any of techniques that appeal to the sense of the user of the portable terminal 101 or 102 may be used.

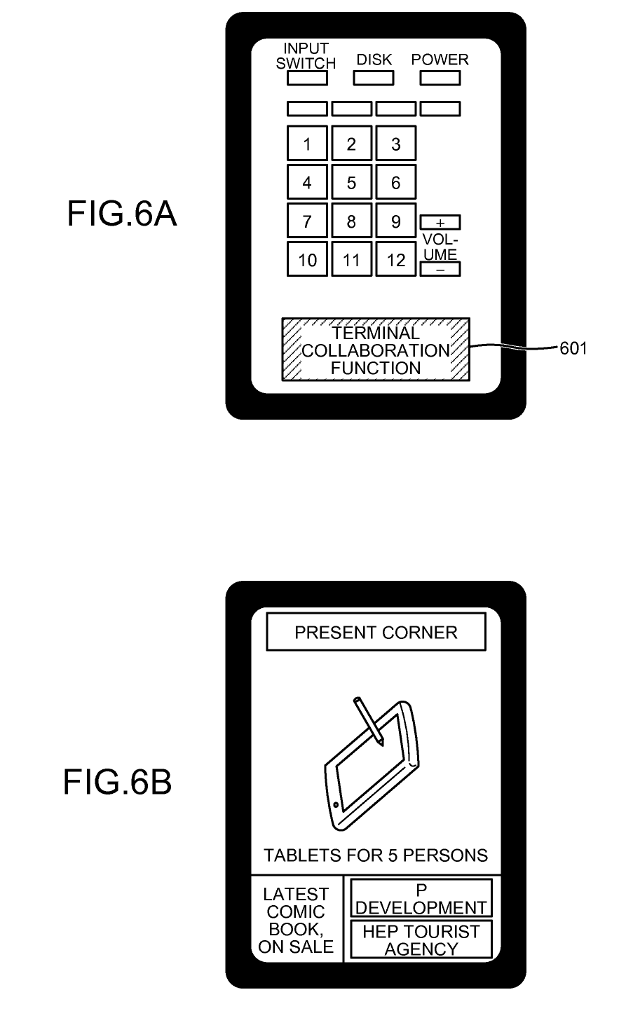

FIGS. 6A and 6B are diagrams each illustrating a second transition example of a screen displayed on the portable terminal 101 or 102. In an example illustrated in FIG. 6A, the display controller 403 has already displayed a terminal collaboration function button 601 in a selectable manner. In this case, when the reception module 405 receives the touch of the terminal collaboration function button 601 via the user interface 303, the screen displayed on the portable terminal 101 or 102 transits.

That is, the transmission controller 401 of the portable terminal 101 or 012 transmits a transmission request of information with respect to an application for performing collaboration to the television device 100 via the network communication module 306. When the television device 100 receives the transmission request, the browser module 208 started in the broadcasting and communication collaboration mode performs processing for collaborating with the portable terminal 101 or 102. For example, when the television device 100 holds a URL of an application capable of being executed in the portable terminal 101 or 102 via the collaborate API 211, the television device 100 controls the network communication module 207 to transmit the URL to the portable terminal 101 or 102.

Furthermore, the portable terminal 101 or 012 invokes and controls the application engine 307 to access the URL when the reception controller 402 receives the URL of an acquisition destination of the application. Accordingly, the application engine 307 accesses the URL and receives the application via the network communication module 306, and executes the received application.

FIG. 6B illustrates an example of a screen displayed on the portable terminal 101 or 102 after the application is executed. As illustrated in FIG. 6B, the application engine 307 can display contents collaborating with a screen (a television program by the Hybridcast and an application, for example) displayed on the television device 100 by executing the application stored at the URL received from the television device 100.

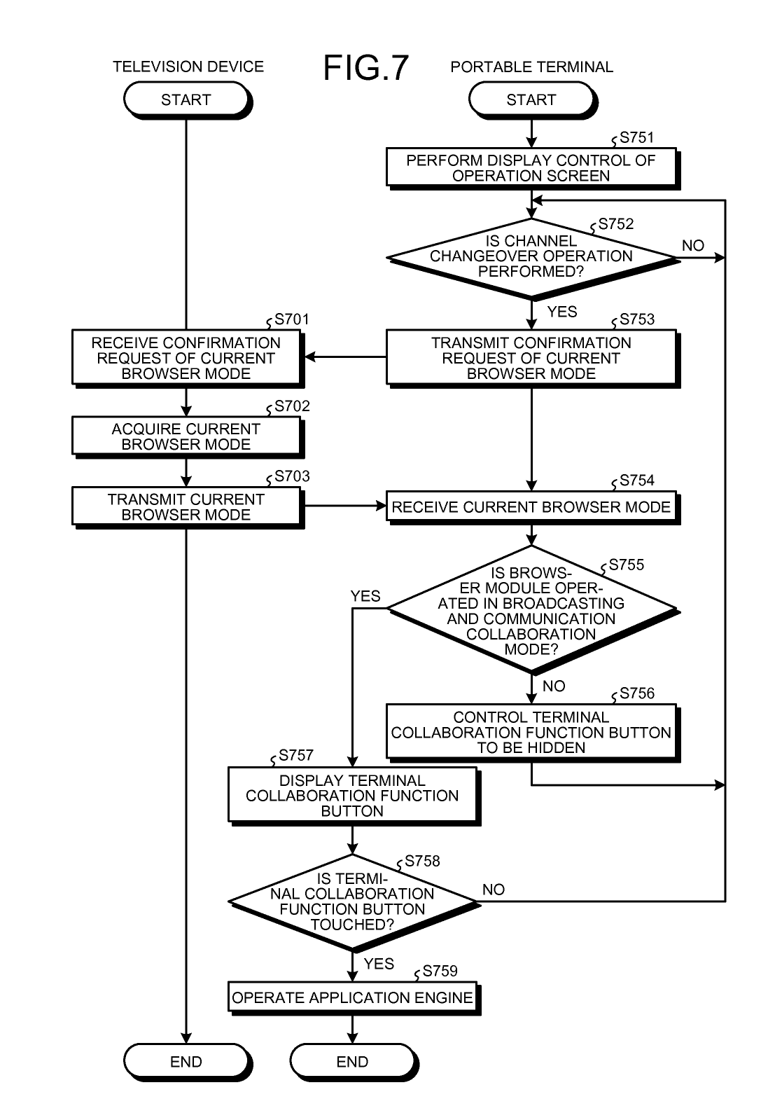

Next, processing with respect to the display control of the television device 100 and the terminal collaboration function button in the portable terminal 101 is explained. FIG. 7 is a flowchart illustrating the procedure of the above-mentioned processing in the television device 100 and the portable terminal 101 according to the first embodiment. With reference to FIG. 7, the procedure of processing in the case of the portable terminal 101 is explained. The portable terminal 102 also performs processing identical with the processing in the case of the portable terminal 101, and the repeated explanation is omitted.

When the companion application 311 is executed in the portable terminal 101, the display controller 403 of the companion application 311 performs a display control of the operation screen of the television device 100 (S751). In an example illustrated in FIG. 7, the terminal collaboration function button 501 is hidden at first.

Next, the reception module 405 determines whether a channel changeover operation or the like is performed (S752). When the channel changeover operation is not performed (No at S752), the processing of S752 is repeated.

In contrast, when the reception module 405 determines that the channel changeover operation or the like was performed (Yes at S752), the transmission controller 401 transmits the confirmation request of the current browser mode to the television device 100 (S753).

Furthermore, the network communication module 207 of the television device 100 receives the confirmation request of the current browser mode from the portable terminal 101 (S701). A controller in the CPU 201 queries the browser module 208 in accordance with the confirmation request and acquires the current browser mode (S702). The network communication module 207 transmits the current browser mode to the portable terminal 101 (S703).

Furthermore, the reception controller 402 receives the current browser mode from the television device 100 (S754). The notification module 404 determines based on the current browser mode whether the browser module 208 of the television device 100 is operated in the broadcasting and communication collaboration mode (S755). When determining that the browser module 208 is not operated in the broadcasting and communication collaboration mode (No at S755), the notification module 404 does not make a notification in particular, the display controller 403 controls the terminal collaboration function button to be hidden (S756) and thereafter, the processing starts from S752.

In contrast, when the notification module 404 determines that the browser module 208 of the television device 100 is operated in the broadcasting and communication collaboration mode (Yes at S755), the display controller 403 displays the terminal collaboration function button and notifies the user of the fact that the television device 100 can correspond to the collaboration (S757).

Thereafter, the reception module 405 determines whether the terminal collaboration function button is touched (S758). When the reception module 405 has determined that the terminal collaboration function button is not touched (No at S758), the processing returns to and starts from S752 again. Although not illustrated in the drawings, even when loop processing at S752 is repeatedly performed, the terminal collaboration function button is held in an effective state when the broadcasting and communication collaboration mode is effective, and the touch of the terminal collaboration function button leads to a screen transition in the same manner as the case of the affirmative determination at S758.

In contrast, when the reception module 405 determines that the terminal collaboration function button is touched (Yes at S758), the application engine 307 is operated (S759).

From the procedure described above, the user can recognize whether the portable terminal 101 can collaborate with the television device 100 according to the browser mode of the television device 100.

Here, in the first embodiment, the explanation has been made with respect to an example that adds a function for collaborating with the television device 100 to an application for operating the television device 100 as the companion application 311. However, the function for collaborating with the television device 100 may be incorporated in an application other than the application for operating the television device 100. Here, in the first embodiment, the explanation has been made with respect to a certain kind of data that can be read by the browser module 208 by taking data provided as the Hybridcast as an example. However, other kinds of data may be used.

### First Modification of First Embodiment

In the first embodiment, the explanation has been made with respect to the example in which the portable terminal 101 or 102 makes the notification to the user based on whether the browser mode of the television device 100 is the broadcasting and communication collaboration mode. However, the first embodiment is not limited to the example that makes the notification based on whether the browser mode is the broadcasting and communication collaboration mode. In a first modification, an example is explained that makes a notification in accordance with the other browser mode.

In the first modification, the reception controller 402 of the portable terminal 101 or 102 receives the fact that the browser module 208 of the television device 100 is in a browser mode for a predetermined service provider from the television device 100. In the browser mode for the predetermined service provider, for example, the browser module 208 starts in a mode for displaying contents provided by the predetermined service provider via the public network 180.

Furthermore, the notification module 404 makes a notification, when recognizing that the browser module 208 is in the browser mode for the predetermined service provider, to a user in such a manner that the user can recognize that the browser module 208 is in the browser mode. For example, the notification may be made with respect to the user by a visual indication, a piece of music, or the like that corresponds to the browser mode. When the predetermined service provider provides an application intended for the portable terminal 101 or 102, the application may be started. In this manner, the notification may be made with respect to a service or a computer program.

### Second Modification of First Embodiment

In the first embodiment, the explanation has been made with respect to an example in which the portable terminal 101 or 102 determines, based on the browser mode of the browser module 208, whether the browser module 208 starts in such a manner that the browser module 208 corresponds to a service that integrates the broadcast and the communication. However, the above-mentioned embodiment is not limited to the example that makes determination based on the browser mode. As a second modification, the portable terminal 101 or 102 does not make determination based on the browser mode but may determine based on whether an API corresponding to a service such as the Hybridcast can be used in the television device 100. That is, the condition that the API can be currently used implies that broadcasting signals by which the API may be used are received. That is, the portable terminal 101 or 102 can confirm whether the television device 100 receives broadcasting signals corresponding to a service such as the Hybridcast by confirming whether an API can be used.

In the second modification, the portable terminal 101 or 102 transmits a request for confirming whether an API (the collaborate API 211, for example) used for the Hybridcast can be used currently in the browser module 208 to the television device 100. Furthermore, the television device 100 transmits information indicating whether the API can be used currently to the portable terminal 101 or 102. The notification module 404 of the portable terminal 101 or 102 performs notification in such a manner that the state of the terminal collaboration function button is switched between a display state and a hidden state based on the information.

### Second Embodiment

In the first embodiment or modifications, the explanation has been made with respect to an example in which the portable terminal 101 or 102 determines whether the television device 100 corresponds to a service such as the Hybridcast based on the browser mode or the API and makes a notification. However, although the service allows a collaboration between broadcasting signals and communication, the service does not necessarily request the collaboration to the portable terminal 101 or 102. That is, there may be a possibility that the portable terminal 101 or 102 is not collaborated even if the portable terminal 101 or 102 invokes the application engine 307.

Accordingly, in the second embodiment, a method for confirming whether an application that can be executed in the portable terminal 101 or 102 exists with respect to the television device 100 is explained.

In the second embodiment, as a method for confirming whether an application capable of being executed in the portable terminal 101 or 102 exists, the portable terminal 101 or 102 confirms whether the television device 100 holds a URL that is the acquisition source of an application for the portable terminal 101 or 102.

The television device 100 according to the second embodiment accesses a data distribution server 152 of a service provider in accordance with additional information contained in broadcasting signals, receives an application from the data distribution server 152, and executes the application. And then, the application invokes setURLForCompanionDevice( ) of the collaborate API 211. Accordingly, the television device 100 can acquire, when a service provider (a broadcasting station, for example) provides an application for the portable terminal 101 or 102, a URL for the application to be executed in the portable terminal 101 or 102. Furthermore, the television device 100 holds the URL acquired thereby, via the collaborate API 211. Due to such a configuration, the television device 100 can set the URL in a state that the portable terminal 101 or 102 can acquire the URL. Here, the second embodiment illustrates one example of a method for acquiring the URL for the application to be executed in the portable terminal 101 or 102. Regardless of the well-known method, any method for acquiring a URL for an application may be used. In the same manner as above, the name of the above-mentioned API is merely exemplified.

The transmission controller 401 of the portable terminal 101 or 102 in the second embodiment periodically polls the television device 100 with respect to whether a URL as an acquisition source of an application exists.

The reception controller 402 receives, as a result of polling the television device 100 by the transmission controller 401, a URL from the television device 100. The URL is an acquisition source of the application collaborating with a television program being broadcasted with broadcasting signals received by the television device 100.

Furthermore, when the reception controller 402 receives a URL, the notification module 404 notifies a user of the reception of the URL. The notification module 404 in the second embodiment makes a notification to the user of the reception of the URL by switching a display state of the terminal collaboration function button from a non-display state to a display state. Here, the second embodiment is not limited to this notification technique. Such as a technique of outputting a visual indication or a sound, or a vibration, any of notification techniques that appeal to the sense of the user may be used.

Furthermore, after the notification module 404 notifies the user of the reception of the URL, the reception module 405 receives an operation for changing from an operation screen to the display of an application in response to the touch of the terminal collaboration function button on the operation screen. In the second embodiment, when the reception module 405 receives the operation for changing from the operation screen to the display of the application, the display controller 403 changes from the operation screen to the screen of the application engine 307 (a browser, for example), and displays the application on the screen of the application engine 307 (a browser, for example).

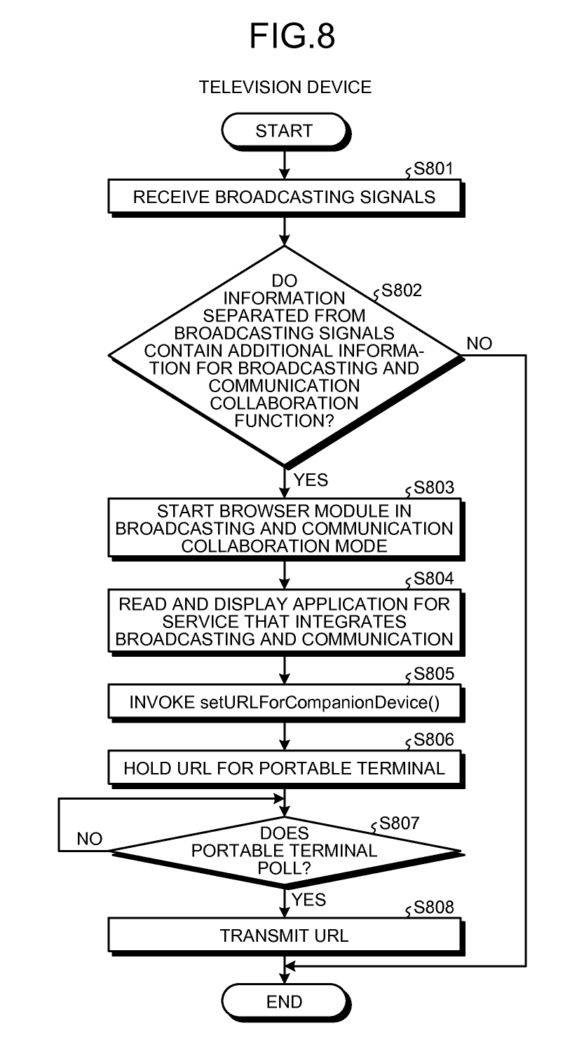

Next, processing until a URL is transmitted for collaborating with the portable terminal 101 or 102 in the television device 100 according to the second embodiment is explained. FIG. 8 is a flowchart illustrating the procedure the above-mentioned processing in the television device 100 in the second embodiment.

First of all, the tuner 204 of the television device 100 receives broadcasting signals via an antenna (not illustrated in the drawings) (S801).

Furthermore, the television device 100 determines whether information separated from broadcasting signals by the demultiplexer 205 contains additional information for collaborating between a broadcast and a communication (that is, additional information for a broadcasting and communication collaboration function) (S802). When the television device 100 determines that the additional information is not contained (No at S802), the processing terminates. In contrast, when the television device 100 determines that the additional information for collaborating between the broadcast and the communication is contained (Yes at S802), the browser module 208 is started in the broadcasting and communication collaboration mode (S803).

The browser module 208 started in a broadcasting and communication collaboration mode accesses a URL contained in the additional information, and reads and displays an application for a service that integrates the broadcast and the communication (S804). Furthermore, the application may be displayed in a superimposed manner on video data contained in the broadcasting signals.

Furthermore, the browser module 208 invokes setURLForCompanionDevice( ) of the collaborate API 211 (S805). Accordingly, the television device 100 acquires the URL for the application to be executed in the portable terminal 101 or 102.

The television device 100 holds the URL for the portable terminal 101 or 102 (S806).

The network communication module 207 determines whether the portable terminal 101 or 012 polls the television device 100. When the portable terminal 101 or 012 does not poll the television device 100, the network communication module 207 stands by as it is, and the processing of S807 is repeated again.

In contrast, when the network communication module 207 determines that the portable terminal 101 or 012 polls the television device 100 (Yes at S807), the network communication module 207 transmits the URL held thereby to the portable terminal 101 or 102 (S808).

The television device 100 performs the above-mentioned processing thus transferring the URL when the portable terminal 101 or 102 polls the television device 100.

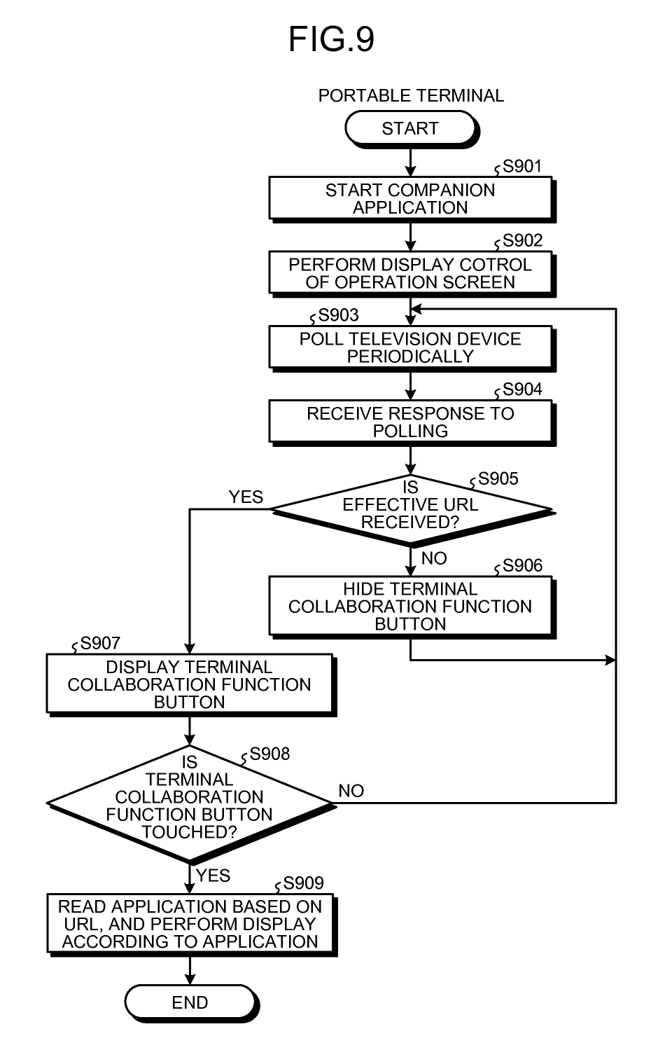

Next, processing for collaborating with the television device 100 in the portable terminal 101 or 102 according to the second embodiment is explained. FIG. 9 is a flowchart illustrating the procedure of processing in the portable terminal 101 according to the second embodiment. Here, in FIG. 9, the explanation is made with respect to the case of the portable terminal 101. However, in the case of the portable terminal 102 also, the identical processing is performed, and its repeated explanation is omitted.

First of all, in the portable terminal 101, the companion application 311 is started (S901). The display controller 403 of the companion application 311 performs a display control of the operation screen of the television device 100 (S902).

The transmission controller 401 of the companion application 311 periodically polls the television device 100 for determining whether the television device 100 holds a URL for acquiring an application for the portable terminal 101 (S903).

Furthermore, the reception controller 402 receives a response to the polling from the television device 100 (S904). The notification module 404 determines whether an acquisition source acquires an effective URL (S905). When determining that the acquisition source cannot acquire the effective URL (No at S905), the notification module 404 controls the display controller 403 to hide the terminal collaboration function button, and notifies the user of the fact that the portable terminal 101 cannot collaborate with the television device 100 (S906). Thereafter, the processing returns to and starts from S903 again.

In contrast, when the notification module 404 determines that the effective URL can be acquired (Yes at S905), the notification module 404 controls the display controller 403 to display the terminal collaboration function button, and notifies the user of the fact that the portable terminal 101 can collaborate with the television device 100 (S907).

Thereafter, the reception module 405 determines whether the terminal collaboration function button is touched (S908). When the reception module 405 determines that the terminal collaboration function button is not touched (No at S908), the processing returns to and starts from S903 again. However, although not illustrated in the drawings, even when the processing returns to S903, if a broadcasting and communication collaboration mode is effective, the terminal collaboration function button remains effective. Therefore, when the terminal collaboration function button is touched, a display screen is changed in the same manner as the case of the affirmative determination at S908.

In contrast, when the reception module 405 determines that the terminal collaboration function button is touched (Yes at S908), the application engine 307 is executed and, at the same time, an application that collaborates with a television program is read based on the URL, and a display according to the application is performed (S909).

The above-mentioned processing procedure allows a user to recognize whether the portable terminal 101 or 102 can collaborate with the television device 100 based on the URL stored in the television device 100.

Here, after the reception controller 402 receives a URL, the transmission controller 401 may also continuously poll the television device 100. Furthermore, when the reception controller 402 receives a URL different from a previously received URL, the notification module 404 makes a notification to a user in such a manner that the user can recognize that the URL is different from the previously received URL.

In the second embodiment, the explanation has been made with respect to an example in which the portable terminal 101 or 102 polls the television device 100 to determine a URL. However, the second embodiment is not limited to the example in which the portable terminal 101 or 102 polls the television device 100. The television device 100 may transmit a push notification to the portable terminal 101 or 012 that establishes connection therewith. For example, it is conceivable that when the television device 100 acquires a URL of an application for the portable terminal 101 or 102 upon invoking setURLForCompanionDevice( ), the television device 100 transmits a push notification of the URL to the portable terminal 101 or 102.

Furthermore, in the second embodiment, the explanation has been made with respect to an example that makes a notification only when a URL is acquired. However, the second embodiment may be combined with a browser mode in the first embodiment. For example, it is conceivable that, to consider a case where the browser mode in the first embodiment is a predetermined browser mode, when a URL is acquired after the terminal collaboration function button is controlled to be displayed, the terminal collaboration function button is further flickered and, at the same time, a sound or a vibration is outputted to makes a notification to a user.

As explained heretofore, according to the first and second embodiments, information with respect to a state of a television device is transferred to a portable terminal, and the portable terminal makes a notification to a user based on the information received thereby. Due to such a constitution, a user can recognize whether a portable terminal currently used is capable of collaborating with the television device thus improving usability. Furthermore, the user can easily get a service that allows a collaboration between the portable terminal and the television device thus improving the degree of satisfaction of a user with broadcasting.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a reception controller configured to receive a browser mode from a reception device, the browser mode being configured to indicate whether a browser of the reception device is executed in a state that a certain kind of data is capable of being read; and
a notification module configured to perform notification when it is determined that the browser is capable of reading the certain kind of data based on the browser mode.

2. The electronic device of claim 1, further comprising a transmission controller configured to transmit a request of the browser mode to the reception device.

3. The electronic device of claim 1, wherein the notification module is configured to perform notification by outputting a sound or a visual indication, or vibrating the electronic device.

4. The electronic device of claim 1, wherein the notification module is configured to perform notification when it is determined that the browser is capable of reading an application as the certain kind of data, the application corresponding to a service in which a broadcasting and a communication are integrated with each other.

5. An electronic device comprising:
a reception controller configured to receive address information for displaying data from a reception device, the data being configured to collaborate with a program broadcasted through broadcasting signals received by the reception device; and
a notification module configured to perform notification with respect to a user that the reception controller has received the address information.

6. The electronic device of claim 5, further comprising:
a display controller configured to display an operation screen for operating the reception device; and
a reception module configured to receive an operation for changing a display from the operation screen displayed by the display controller to the data after the notification module performs notification.

7. The electronic device of claim 6, wherein the display controller is configured to change the display from the operation screen to a screen of a browser application upon receipt of the operation by the reception module, and to display the data on the screen of the browser application.

8. A control method executable in the electronic device, the control method comprising:
receiving a browser mode from a reception device, the browser mode being configured to indicate whether a browser of the reception device is executed in a state that a certain kind of data is capable of being read; and
performing notification when it is determined that the browser is capable of reading the certain kind of data based on the browser mode.

9. The control method of claim 8, further comprising transmitting a request of the browser mode to the reception device.

10. The control method of claim 8, wherein the performing comprises outputting a sound or a visual indication, or vibrating the electronic device.

11. The control method of claim 8, wherein the performing is performed when it is determined that the browser is capable of reading an application as the certain kind of data, the application corresponding to a service in which a broadcasting and a communication are integrated with each other.

12. A control method executable in the electronic device, the control method comprising:
receiving address information for displaying data from a reception device, the data being configured to collaborate with a program broadcasted through broadcasting signals received by the reception device; and
performing notification with respect to a user that the address information is received at the receiving.

13. The method of claim 12, further comprising:
displaying an operation screen for operating the reception device; and
receiving an operation for changing a display from the operation screen to the data after the performing.

14. The method of claim 13, wherein the displaying comprises changing, when the receiving is performed, the display from the operation screen to a screen of a browser application, and displaying the data on the screen of the browser application.

15. A computer program product having a non-transitory computer readable medium including programmed instructions, wherein the instructions, when executed by a computer, cause the computer to perform:
receiving a browser mode from a reception device, the browser mode being configured to indicate whether a browser of the reception device is executed in a state that a certain kind of data is capable of being read; and
performing notification when it is determined that the browser is capable of reading the certain kind of data based on the browser mode.

16. The computer program product of claim 15, wherein the instructions cause the computer to further perform transmitting a request of the browser mode to the reception device.

17. The computer program product of claim 15, wherein the performing comprises outputting a sound or a visual indication, or vibrating the electronic device.

18. The computer program product of claim 15, wherein the performing comprises performing notification when it is determined that the browser is capable of reading an application as the certain kind of data, the application corresponding to a service in which a broadcasting and a communication are integrated with each other.

19. A computer program product having a non-transitory computer readable medium including programmed instructions, wherein the instructions, when executed by a computer, cause the computer to perform:
receiving address information for displaying data from a reception device, the data being configured to collaborate with a program broadcasted through broadcasting signals received by the reception device; and
performing notification with respect to a user that the address information is received at the receiving.

20. The computer program product of claim 19, wherein the instructions cause the computer to further perform:
displaying an operation screen for operating the reception device; and
receiving an operation for changing a display from the operation screen to the data after the performing.
